(19) United States
(12) Patent Application Publication
(10) Pub. No.: US 2002/0078885 A1
(43) Pub. Date: Jun. 27, 2002

(54) Workpiece processing apparatus and methods

(76) Inventors: Masakatsu Masaki, Kariya-shi (JP); Takeshi Sakamaki, Toyota-shi (JP)

Correspondence Address: MORGAN & FINNEGAN, L.L.P., 345 Park Avenue, New York, NY, 10154, US

(21) Appl. No.: 09/982,035

(22) Filed: Oct. 17, 2001

(30) Foreign Application Priority Data
Oct. 19, 2000 (JP) 2000-319762

(51) Int. Cl. B05C 5/00

(52) U.S. Cl. 118/314; 118/305

(57) ABSTRACT

A supporting structure (10) moves along panel joints (J), (J) of a roof panel (R) and a roof side panel (S) of an automobile body (B). Two sealant coating devices (20, 30), which each have a coating head, are provided on the left and right sides of the supporting structure (10). The sealant coating devices (20, 30) are mounted on the supporting structure 10 in such a manner that the coating heads can move in the width direction as well as in the vertical direction of the automobile body. According to this arrangement, the sealant coating devices (20, 30) move in such a manner that the coating head follows the panel joints (J), (J) while the supporting structure (10) along the longitudinal direction of the automobile body (B).

### FIELD OF THE INVENTION

The present invention relates to workpiece processing apparatus and methods and more particularly, apparatus and methods for processing an automobile body. For example, the present invention relates to methods and apparatus for coating a sealing material (called “sealant”) along the joints of a roof panel and a roof side panel of an automobile body and/or for cleaning the automobile body by blowing compressed air along the joints prior to coating the sealant.

### RELATED ART

Japanese Utility Model Publication No. 2-12484 (1990) teaches a coating device for coating a sealant onto the joints of a roof panel and a roof side panel of an automobile body (hereafter “panel joints”). In the known sealant coating device, a spring positions and upwardly presses a workpiece under a coating head that moves along a predetermined path. The workpiece can be moved in the vertical direction (in a floating condition). While a guiding roller attached to the coating head is moved along the joints of the workpiece (i.e., the sealant coating device), the sealant is coated onto the panel joints.

In the known sealant coating device, as the coating head moves along the predetermined path, the workpiece follows the coating head by moving up or down in accordance with the shape of the portion of the workpiece that is being coated with sealant. In other words, the relative positions of the coating head and the portion of the workpiece always remain constant. Consequently, the sealant can be efficiently applied to the workpiece without utilizing manual labor, even when the portion of the workpiece that is being coated with sealant has a curved surface.

The workpiece is maintained in a floating condition by the known coating device so that the workpiece follows the sealant coating head. Thus, the known coating device effectively applies sealant to the joints of relatively small panels.

However, application of the sealant becomes difficult when the sealant is coated to the joints of large panels, e.g., the joints of a roof panel and a roof side panel of an automobile roof. For example, the workpiece supporting device must be made very large and complex in order to support the entire automobile body in a floating condition. In addition, it is difficult to accurately coat the sealant along the workpiece when a relatively large workpiece is supported in a floating condition.

### SUMMARY OF THE INVENTION

It is, accordingly, one object of the present teachings to provide improved workpiece processing apparatus and methods that may be, for example, utilized to process a relatively large workpiece, such as an automobile body.

In one aspect of the present teachings, sealant coating devices and methods for applying sealant to a joint are taught. In another aspect of the present teachings, methods and apparatus are taught for cleaning a joint by blowing compressed air along the joint. The latter methods and apparatus may be preferably utilized prior to coating the sealant. Further, the devices and methods of these two aspects of the present teachings may be particularly advantageous when utilized to process an automobile body, although naturally other applications of the present teachings are contemplated.

In another aspect of the present teachings, the functional portion of the sealant coating device can accurately move along the portion of the workpiece that is being coated and a large and complex workpiece supporting device is not required, even for a large workpiece such as an automobile body.

In one embodiment of the present teachings, the sealant coating device may preferably include a processing head that is designed to apply the sealant to the workpiece (e.g. a panel joint). The processing head may include a spray nozzle for applying the sealant to the panel joint and a supporting structure or device that permits the processing head to freely move while the processing head moves along the workpiece.

For example, while the supporting structure of the sealant coating device moves relative to the workpiece, the processing head may be supported in a condition so that it can move freely and independently of the supporting structure. As a result, the need to support the work-piece in a floating condition is eliminated. Therefore, a large and complex supporting device for the workpiece is not required with the present teachings, which makes the present teachings particularly advantageous for processing a large workpiece. In addition, because the workpiece is not supported in a floating condition, as in the known art, the processing head can accurately move along the portion of the workpiece that is being processed.

In another aspect of the present teachings, methods are taught for moving the supporting structure relative to the portion of the workpiece being processed. In addition, methods are taught for moving the workpiece, moving the supporting structure, or moving both the workpiece and the supporting structure. Various methods may be utilized to support the processing head so that it can move freely with respect to the workpiece. Moreover, various methods can be utilized as long as the processing head can follow the portion of the workpiece that will be processed.

Additional objects, features and advantages of the present invention will be readily understood after reading the following detailed description together with the accompanying drawings and the claims.

### BRIEF DESCRIPTION OF THE DRAWINGS

FIG. 1 shows plan view of a first representative embodiment of a sealant coating device and an automobile body according to the present teachings.

FIG. 2 shows a front view of the first representative embodiment.

FIG. 3 shows a plan view of the sealant coating device of the first representative embodiment.

FIG. 4 shows a front view of the sealant coating device of the first representative embodiment.

FIG. 5 shows a front view of the left side of the sealant coating device of the first representative embodiment.

FIG. 6 shows a view along line VI-VI identified in FIG. 5, which is thus a side view of the left side of the sealant coating device of the first representative embodiment.

### DETAILED DESCRIPTION OF THE INVENTION

In one embodiment of the present teachings, a processing head may be supported so as to freely move in a direction that is substantially parallel to a line connecting a support structure and a workpiece. In another embodiment of the present teachings, the processing head can be supported so as to freely move in a direction that is substantially parallel to a line orthogonal to the line connecting the support structure and the workpiece. In a further embodiment of the present teachings, the processing head can be supported so as to freely move in a direction that is substantially parallel to a line connecting the supporting structure and the workpiece and in a direction that is substantially parallel to a line orthogonal to the line connecting the supporting structure and the workpiece.

In a further embodiment of the present teachings, the workpiece may be an automobile body. In this case, the processing head can be supported so as to freely move up or down in the vertical direction with respect to the automobile body. In addition or in the alternative, the processing head can be supported so as to freely move in the horizontal or width direction of the automobile body.

In another embodiment of the present teachings, a driving device can be provided to move the processing head to a starting or original position with respect to the workpiece. Further, the driving device may prevent interference between the processing head and the workpiece. For example, a first driving device may be provided to move the processing head in a direction that is substantially parallel to the line connecting the support structure and the workpiece. In addition or in the alternative, a second driving device may be provided to move the processing head in a direction that is substantially parallel to a line orthogonal to the line connecting the support structure and the workpiece.

In another embodiment of the present teachings, a coating head may be utilized to coat or apply a sealant onto the joints of automobile panels. In such an embodiment, the coating head preferably can move relative to the automobile panels so as to follow the panel joints. In known sealant coating devices, a supporting structure supports the workpiece in a floating condition, which necessitates a large and complex supporting device if the workpiece to be processed is relatively large. However, according to the present teachings, workpiece processing devices and processing methods are taught that avoid the need for a large and complex supporting device, even when a large workpiece must be processed, such as an automobile body.

In another embodiment of the present teachings, supporting structures are taught that support the processing head so that it is free to move. The supporting structure moves relative to the workpiece along the portion of the workpiece that is being processed. According to this embodiment, it is not necessary to support the workpiece in a floating condition. Consequently, a large and complex supporting device is not necessary even when large workpieces are processed. Moreover, because the workpiece is not supported in a floating condition, the processing head can accurately move along the workpiece.

Various methods are also taught for (1) moving the supporting structure relative to the portion of the workpiece being processed, (2) moving the workpiece, (3) moving the supporting structure and (4) moving both the workpiece and the supporting structure. These methods may be utilized together or independently. If both the workpiece and the supporting structure are moved, the workpiece and the coating head can move in different directions, or in the same direction. Further, if both the workpiece and the supporting structure are moved, the relative speed of movement could be set appropriately according to the type of processing that is being performed. If only the workpiece is moved, for example, it may be possible to improve processing efficiency.

In another embodiment of the present teachings, methods are taught for supporting the processing head so that it is free to move relative to the supporting structure. Various methods can be utilized as long as the processing head can follow the workpiece when the supporting structure moves relative to the workpiece.

In another embodiment of the present teachings, the supporting structure may support the processing head so that it is allowed to move substantially in parallel with an imaginary line that connects the supporting structure and the portion of the workpiece being processed. According to this arrangement, the processing head can follow the portion of the workpiece being processed, even if the portion of the workpiece being processed shifts or moves in a direction that is substantially parallel to the imaginary line connecting the supporting structure and the portion of the workpiece being processed. For example, if the workpiece is an automobile body, the processing head may be, e.g., disposed above or below the automobile body. In this case, the supporting structure can support the processing head so that the processing head can move up or down with respect to a vertical direction of the automobile body. As a result, the processing head can follow the workpiece even if the portion of the workpiece to be processed moves or shifts along the vertical direction. Thus, curved structures can be easily processed.

In another embodiment of the present teachings, the supporting structure may support the processing head so that the supporting structure can move substantially in parallel with a line that is orthogonal to the imaginary line connecting the supporting structure and the portion of the workpiece being processed. According to this arrangement, the processing head can still process the workpiece, even if the portion of the workpiece being processed moves or shifts in a direction that is substantially parallel to the line that is orthogonal to the imaginary line connecting the supporting structure and the portion of the workpiece being processed. For example, the workpiece may be an automobile body and the processing head may be disposed above or below the automobile body. In this case, the supporting structure may support the processing head so that the processing head can move in the horizontal or width direction of the automobile body. As a result, the processing head can follow the workpiece in the horizontal or width direction of the automobile body even if the portion of the workpiece being processed moves or shifts in the horizontal or width direction. Thus, curved surfaces can be processed in this embodiment as well.

In another embodiment of the present teachings, the supporting structure may support the processing head so that supporting structure can move substantially in parallel with the imaginary line connecting the supporting structure and the portion of the workpiece being processed. In addition, the supporting structure may support the processing head so that supporting structure can also move substantially in parallel to the line that is orthogonal to the imaginary line connecting the supporting structure and the portion of the workpiece being processed. According to this arrangement, the processing head can follow shifts or movement of the portion of the workpiece being processed in a direction substantially parallel to the imaginary line connecting the supporting structure and the portion of the workpiece being processed, and can also follow shifts or movements of the portion of the workpiece being processed in a direction substantially parallel to the line that is orthogonal to the imaginary line connecting the supporting structure and the portion of the workpiece being processed.

As in the previous embodiments, the workpiece may be an automobile body and the processing head may be disposed above or below the automobile body. In this embodiment, the supporting structure can support the processing head so that the supporting structure can move in the up or down (e.g. vertical) direction, as well as in the width (e.g. horizontal) direction of the automobile body. Therefore, the processing head can follow shifts or movement of the workpiece portion being processed in both the up or down (e.g. vertical) direction and the width (e.g. horizontal) direction of the automobile body. The processing head can be supported to freely move on the supporting structure with or without an intermediate supporting mechanism.

If the processing head interferes with the portion of the workpiece being processed, it may be necessary to withdraw the processing head. Further, if the processing head is not correctly positioned at the beginning of the portion of the workpiece that will be processed, it is necessary to move the processing head to the starting position of the workpiece. Therefore, one or more driving devices may preferably be utilized to move the processing head.

Thus, in another embodiment of the present teachings, a first driving device may be utilized to move the processing head in a direction substantially parallel to the imaginary line connecting the supporting structure and the workpiece. Thus, if the workpiece is e.g. an automobile body, a driving device can be provided to move the processing head up or down in the vertical direction with respect to the automobile body. In addition or in the alternative, a driving device can be provided to move the processing head in the horizontal or width direction of the automobile body.

In a further embodiment of the present teachings, the first (e.g. vertical direction) driving device and the second (e.g. transverse direction) driving device may be utilized together. Thus, if the work piece is e.g. an automobile body, the vertical direction driving device may be provided to move the processing head in the up or down (e.g. vertical) direction with respect to the automobile body, and the transverse direction driving device may be provided to move the processing in the horizontal or width direction with respect to the automobile body.

Preferably, each driving device may be controlled based on the relative positions of the workpiece and the supporting structure. In this further embodiment, a position detector can be provided to detect the relative position of the workpiece and the supporting structure and to communicate this position information to a controller (e.g. a processor), which preferably controls the movement of the driving device. Thus, the driving device of the processing head may be used, for example, if the processing head interferes with the workpiece, or if the processing head must be moved to the starting position of the portion of the workpiece that will be processed. In another embodiment, a position detector may be provided to detect the relative position between the processing head and the supporting structure. The driving device may control movement of the processing head and the driving device may be controlled based on a detection signal that is outputted from the position detector.

Each of the additional features and method steps disclosed above and below may be utilized separately or in conjunction with other features and method steps to provide improved workpiece processing devices and methods for designing and using such workpiece processing devices. Representative examples of the present invention, which examples utilize many of these additional features and method steps in conjunction, will now be described in detail with reference to the drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detail description may not be necessary to practice the invention in the broadest sense, and are instead taught merely to particularly describe some representative examples of the invention, which detailed description will now be given with reference to the accompanying drawings.

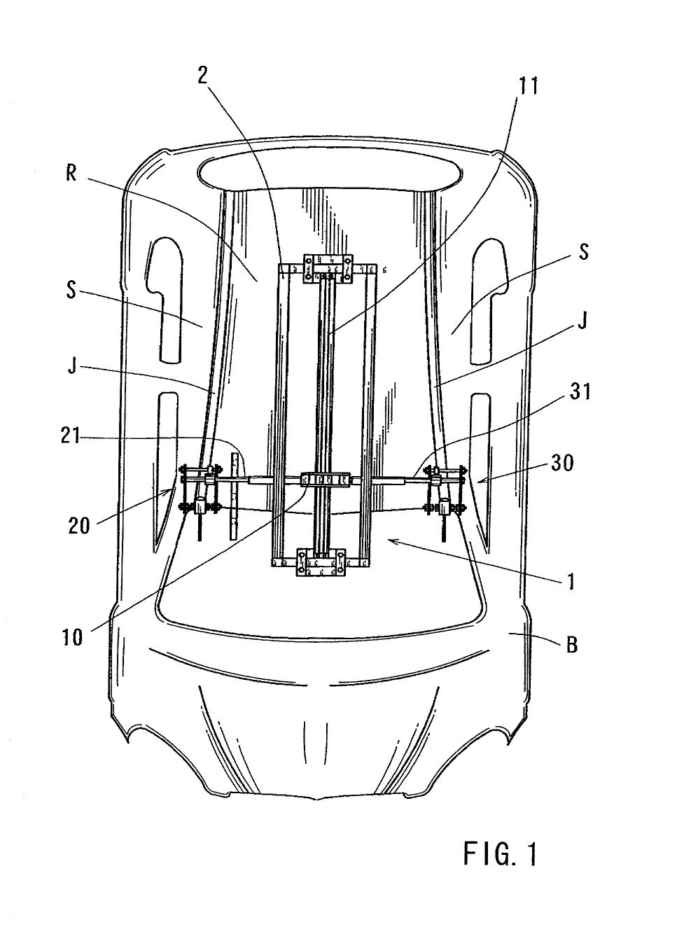

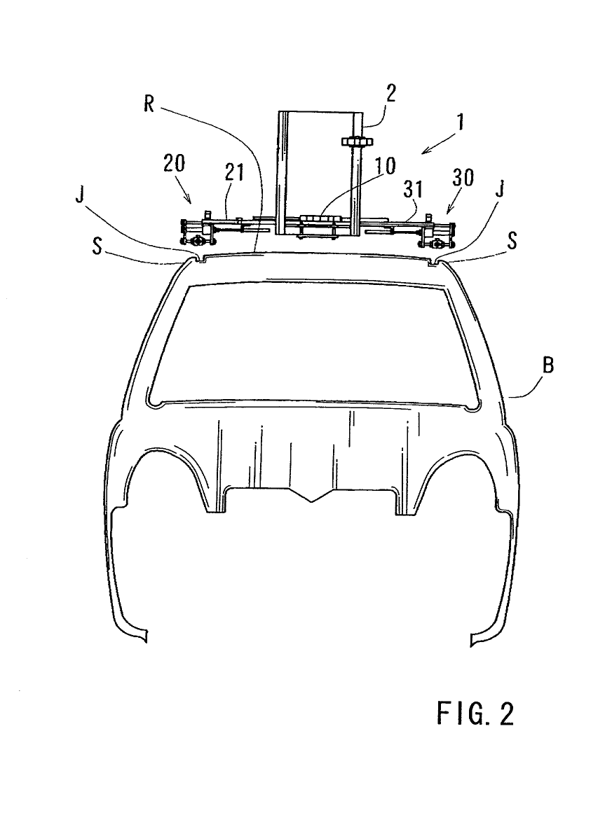

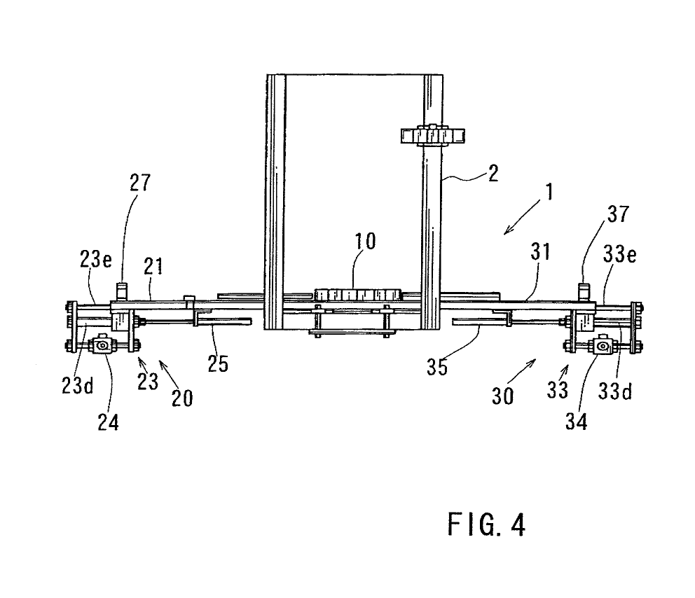

A detailed representative example of the present teachings will be described with reference to FIGS. 1 to 6. In this representative example, a sealant coating device 1 may coat a sealant (C) onto the joints of a roof panel (R) and a roof side panel (S) of an automobile body (B) (hereafter “panel joint” (J)). The panel joint (J) may have, e.g., a concave shape, as shown in FIG. 2, or other shapes.

In the following description, the automobile body (B), as viewed from the front, will be referenced in defining the left and right directions. In other words, the left side in FIGS. 1 to 5 (which in fact corresponds to the right side of the automobile body (B)) will be defined as “the left side.” Similarly, the right side in FIGS. 1 to 5 (which in fact corresponds to the left side of the automobile body (B)) will be defined as “the right side.”

The representative sealant coating device 1 may, e.g., include a supporting structure 10 and two sealant coating devices 20, 30, as shown in FIGS. 2 to 4. A rod-less type, sliding cylinder 11 may be provided within the supporting structure 10 and along the transfer line of the automobile body (B), so that the rod-less type, sliding cylinder 11 can move within a pre-defined range. The sliding cylinder 11 may be mounted on a rack 2 that is, e.g., suspended from the ceiling of the plant over the transfer line of the automobile body (B).

Arms 21, 31 may extend outwardly from the left side and right sides of the supporting structure 10. The sealant coating devices 20, 30 may be installed on the tip or outer portions of the arms 21, 31. The sealant coating devices 20, 30 are preferably constructed so that they are substantially identical, but symmetrically disposed about the sliding cylinder 11. Therefore, in the following description, it is only necessary to describe one sealant coating device (e.g. sealant coating device 20, which is on the left side) in detail, because the other sealant coating device may have substantially the same construction.

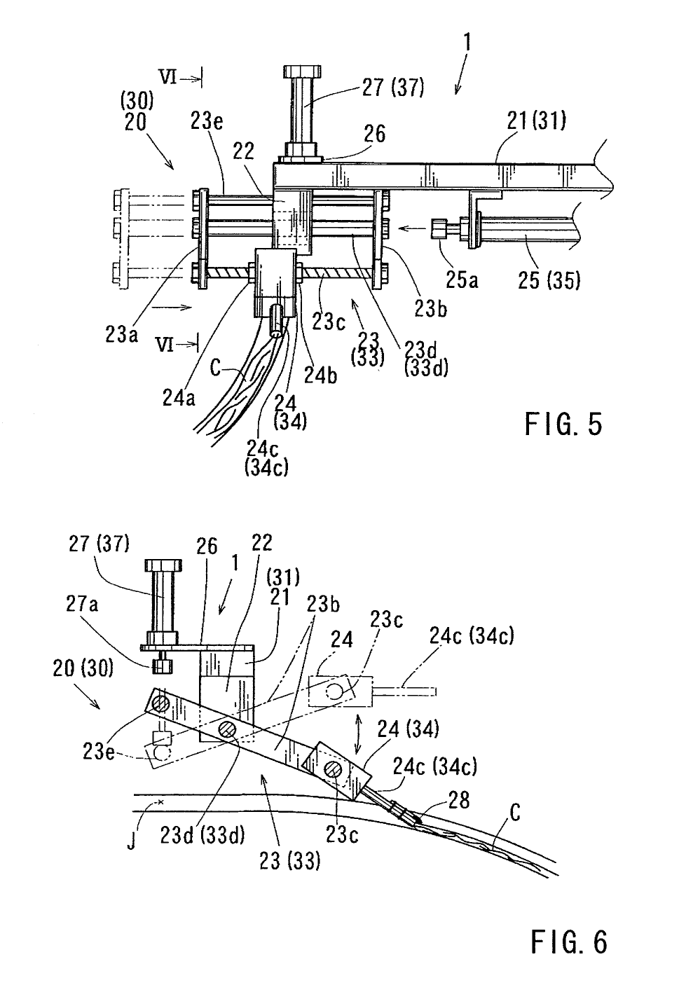

Sealant coating device 20 is shown in greater detail in FIGS. 5 and 6. Furthermore, the reference numerals assigned to each element of sealant coating device 20 (left side) substantially correspond to the reference numerals assigned to each element of sealant coating device 30 (right side) by a difference of 10. Thus, in FIGS. 5 and 6, each element of sealant coating device 30 that substantially corresponds to an element of sealant coating device 20 (left side) is indicated in parenthesis.

Referring to FIGS. 5 and 6, a supporting block 22 may be attached to the lower surface of the tip or end portion of the arm 21. A follower frame 23 may be attached to the supporting block 22 in such a manner that it can slide left or right (width direction of the automobile body) and can rotate in the up or down (vertical) directions. The follower frame 23 may include left and right longitudinal frames 23a, 23b, which resemble a band plate, and three transverse frames 23c, 23d, 23e. The transverse frames 23c, 23d, 23e may be fixed to the longitudinal frames 23a, 23b by bridging structures at substantially the front end, the center and the rear end. Hereinafter, transverse frame 23c will be called the front transverse frame 23c, transverse frame 23d will be called the middle transverse frame 23d, and transverse frame 23e will be called the rear transverse frame 23e.

The supporting block 22 preferably supports the middle transverse frame 23d so that the middle transverse frame 23d can slide and rotate. According to this arrangement, the follower frame 23 can slide in the left or right direction (width direction of the automobile body) and rotate about the middle transverse frame 23d in the up or down (vertical) direction. The middle transverse frame 23d may be attached at a position closer to the rear transverse frame 23e that is shown in the drawings. It is further noted that the middle transverse frame 23d is one representative example of a supporting structure for supporting a processing head according to the present teachings.

A driving cylinder 25 for the left and right directions is provided on the lower side of the left arm 21 and on the side of the follower frame 23. The driving cylinder 25 may be installed substantially along the same axis as the middle transverse frame 23d and the rod 25a of the driving cylinder may be directed toward the left side. When the driving cylinder 25 is activated to project or extend the tip of the rod 25a to the left as shown in FIG. 5, the tip of the rod 25a moves toward the left side approximately along the same axis as the middle transverse frame 23d. The rod 25a then contacts the right side surface of the longitudinal frame 23b and the follower frame 23 moves to an outer position (i.e. leftward position in FIG. 5) with respect to the width direction of automobile body B. The dotted line in FIG. 5 represents the original position of the follower frame 23 when it has been pushed leftward by the rod 25a of driving cylinder 25.

When the driving cylinder 25 withdraws or retracts the tip of the rod 25a toward the right side of FIG. 5, the follower frame 23 is released to freely move with respect to the width direction of the automobile body. In this situation, the follower frame 23 can move with respect to the width direction of the automobile body in response to movement of the sealant coating device 20 (e.g., nozzle 24c of the coating head 24) as it follows the panel joints (J), which operation will be described in further detail below.

A screw axis is used in the front transverse frame 23c to attach the longitudinal frames 23a, 23b near the front end in a bridging fashion. A coating head 24 may be provided to coat the sealant on the panel joints (J) and may be attached in substantially the central portion of the front transverse frame 23c. The attachment position of the coating head 24 along the longitudinal axis of the front transverse frame 23c can be adjusted by adjusting the positions of fixing nuts 24a, 24b.

A nozzle 24c may be utilized to spray the sealant (C) and can be disposed so as to protrude forward of the front surface of the coating head 24. A hose (not shown) may be connected to the rear surface of the coating head 24 in order to supply the sealant (C) to the coating head 24. Coating head 24 is one representative embodiment of a processing head according to the present teachings and those skilled in the art will recognize that other types of processing heads may be utilized instead of or in addition to the coating head 24.

A driving cylinder 27 also may be provided to control the position of the follower frame 23 in the vertical direction. This driving cylinder 27 may be disposed substantially at the tip or end portion of the left arm 21 via a base 26, as shown in FIGS. 5 and 6. The driving cylinder 27 may be mounted on the upper side of the rear transverse frame 23. When the driving cylinder 27 is activated and rod 27a moves downward as shown in FIGS. 5 and 6, the tip of the rod 27a contacts the rear transverse frame 23e of the follower frame 23. As a result, the rear transverse frame 23e will move lower and the follower frame 23 will rotate about the middle transverse frame 23d in a direction that will cause the coating head 24 to move or pivot upward (counter clockwise direction in FIG. 6).

In the following description, when the driving cylinder 27 extends rod 27a downward, the coating head 24 is forced to move or pivot upward. The original position of the coating head 24 is shown by the dotted line in FIG. 6. When the driving cylinder 27 withdraws rod 27a upward, the follower frame 23 will rotate or pivot about the middle transverse frame 23d in a direction so as to cause the coating head 24 to move or pivot lower (clockwise direction in FIG. 6), due to the weight of the coating head 24. When the follower frame 23 rotates or pivots so that the coating head 24 moves lower, the tip of the nozzle 24c will contact the panel joint (J).

As described above, the driving cylinder 25 is mounted or disposed substantially along the same axis as the middle transverse frame 23d (i.e. the longitudinal axis of the middle transverse frame 23d). Further, the follower frame 23 rotates or pivots about the middle transverse frame 23d. Therefore, the follower frame 23 can move with respect to the width direction of the automobile body as a result of being driven by driving cylinder 25 and the movement in the width direction may be independent of the rotated or pivoted position of the follower frame 23. In addition, the follower frame 23 can rotate or pivot (to move the coating head 24 up or down) as a result of being driven by the driving cylinder 27. Further, this pivoting or rotating movement can be independent of the position of the follower frame 23 with respect to the width direction of the automobile body.

A brush 28 optionally may be provided at the tip of the nozzle 24c of the coating head 24. The brush 28 may smooth the sealant (C) that has been sprayed from the nozzle 24c.

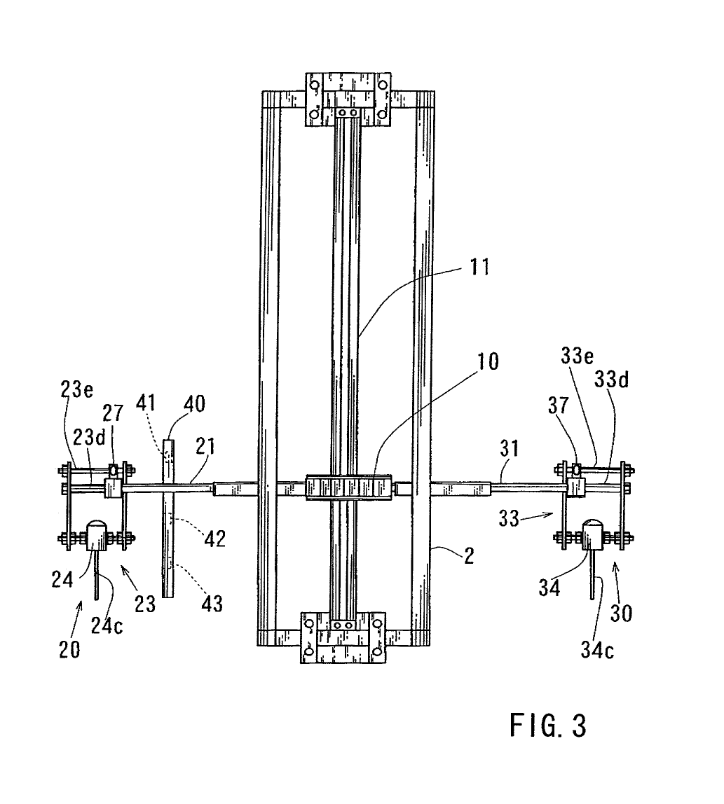

Referring back to FIG. 3, a sensor base 40 may be provided substantially in the middle of the longitudinal axis of the left arm 21. The sensor base 40 may have a long band-plate shape that is disposed along the front-to-rear direction of the automobile body (B). In this representative embodiment, three photoelectric sensors 41, 42, 43 may be installed on the sensor base 40. The photoelectric sensors 41, 42 43 may preferably detect the position of the automobile body (B) as the automobile body (B) moves from the top toward the bottom of the view shown in FIG. 3. The sensors 41, 42, 43 also preferably output detection signals that are supplied or communicated to a control device (not shown), which control device (or controller) preferably controls the movement of the sealant coating device 1. The control device may be a general purpose processor or any other device that is capable of controlling the movement of the sealant coating device 1 in response to positional information generated by the sensors 41, 42, 43.

In the following description, the photoelectric sensor 41 on the backside (topside in FIG. 3) of the automobile body (B) will called the first photoelectric sensor 41. The photoelectric sensor 43 on the front side (bottom side in FIG. 3) will be called the third photoelectric sensor 43. The photoelectric sensor 42 in the middle will be called the second photoelectric sensor 42. The spacing of the first, second and third photoelectric sensors 41, 42, 43 (i.e. the spacing in the fore and aft direction of the automobile body (B)) is preferably selected to permit each part of the sealant coating device 1 to operate at an appropriate timing based on the relative position of the sealant coating device 1 and the automobile body (B). A representative method for operating the first, second and third photoelectric sensors 41, 42 43 will be discussed in greater detail below.

Referring back to FIG. 1, the supporting structure 10 is shown in a standby state and is positioned at the original or starting position. In this standby state, the supporting structure 10 is positioned towards the front side of the sliding cylinder 11.

In the standby state, the driving cylinders 25, 35, which control movement in the left and right directions, are activated so that the rods 25a (35a) are fully projected or extended from the driving cylinders 25, 35. Therefore, the follower frames 23, 33 are positioned towards the outer side of the automobile body with respect to the width or horizontal direction of the automobile body (B). This position corresponds to the original or starting position that is shown by a dotted line in FIG. 5. Therefore, the left and right coating heads 24, 34, and thus the nozzles 24c, 34c, are positioned at the widest spacing or distance from each other. Naturally, the distance between the nozzles 24c, 34c in the standby state (original position) is selected to correspond to the distance between the front end portions of the panel joints (J), (J) of the automobile body (B).

Furthermore, in this standby state, the rods 27a (37a) of driving cylinders 27, 37 are extended or projected, so that the follower frames 23, 33 are rotated or pivoted to upwardly position the coating heads 24, 34. This position corresponds to the original or starting position with respect to the vertical direction and is shown by a dotted line in FIG. 6. Thus, interference between the sealant coating devices 20, 30 and the automobile body (B) is avoided.

In the standby state, the automobile body (B) is moved toward the bottom of the sealant coating device 1 from the top toward the bottom of the view shown in FIG. 1. As the automobile body (B) moves towards of the sealant coating device 1, the first photoelectric sensor 41 will detect the front end of the roof panel (R) of the automobile body (B). When the first photoelectric sensor 41 outputs a detection signal, the controller activates both the left and right driving cylinders 27, 37, thereby causing rods 27a (37a) to withdraw toward a retracted position. As a result, the left and right follower frames 23, 33 will rotate or pivot, due the weight of coating heads 24, 34, about the middle transverse frames 23d, 33d. Thus, the coating heads 24, 34 will rotate or pivot in a direction towards the automobile body (B), which is clockwise as shown in FIG. 6. Consequently, the nozzles 24c, 34c of the coating heads 24, 34 will assume a position that is facing diagonally downward, as shown by solid lines in FIG. 6.

As the automobile body (B) further moves, the second photoelectric sensor 42 will detect the front edge of the roof panel (R) and output a detection signal to the controller. In response, the controller preferably activates the slide cylinder 11, thereby causing the supporting structure 10 and the sealant coating devices 20, 30 to move toward the rear of the automobile body (B). Immediately after the left and right sealant coating devices 20, 30 begin to move, the tips of nozzles 24c, 34c of the left and right coating heads 24, 34 slip or drop into the panel joints (J), (J).

At about the same time, the third photoelectric sensor 43 will detect the front edge of roof panel (R) and output a detection signal to the controller. In response, sealant (C) is supplied to the coating heads 24, 34 and sprayed from the tips of nozzles 23c, 24c. Further, the driving cylinders 25, 35 are activated to withdraw rods 25a (35a) to a retracted position. Therefore, the left and right follower frames 23, 33 will become free to move or slide with respect to the width direction of the automobile body (B). Thus, as the automobile body (B) moves forward, the supporting structure 10 moves toward the rear and the panel joints (J), (J) can be quickly coated with the sealant (C).

As described above, when the third photoelectric sensor 43 detects the roof (R), the left and right follower frames 23, 33 become free to move or slide with respect to the left and right arms 21, 31 and thus, with respect to the width direction of the automobile body (B). Also, the left and right follower frames 23, 33 become free to rotate or pivot about the middle transverse frames 23d, 33d. Thus, the tips of nozzles 24c, 34c of the left and right coating head 24, 34 will slip or drop into the interior of the panel joints (J), (J).

In this representative embodiment, while the left and right sealant coating devices 20, 30 move toward the rear of the automobile body (B), the left and right follower frames 23, 33 follow any shifts or changes in the distance between the two panel joints (J), (J) with respect to the width direction of automobile. For example, the distance between such panel joints generally becomes narrower along the length direction of the automobile body (B). Further, the position of the panel joints in the vertical or height direction of the automobile body (B) typically becomes higher and then lower along the length direction of the automobile body (B). Thus, according to the present teachings, the left and right follower frames 23, 33 can move or slide with respect to the width direction of the automobile and can rotate or pivot about the middle transverse frames 23d, 33d. Therefore, the tips of the nozzles 24c, 34c can accurately follow the side walls and bottom of the panel joints (J), (J) by making the nozzles 23c, 24c follow the panel joints (J), (J).

As the supporting structure 10 approaches the rear edge of the slide cylinder 1, and as the process of coating sealant (C) reaches its final stage, the second photoelectric sensor 42 will stop detecting the roof panel (R). Thus, the controller will preferably stop the supply of sealant (C) to the left and right coating heads 24, 34. Further, when the second photoelectric sensor 42 stops detecting the roof panel (R), the driving cylinders 27, 37 and the driving cylinders 25, 35 are activated to project the respective rods 25a, 27a, 35a, 37a. Therefore, the follower frames 23, 33 rotate or pivot about the middle transverse frames 23d, 33d. Therefore, the coating heads 24c, 34c will be upwardly positioned and will move toward the outer side of width direction of the automobile body (in mutually separating direction). In other words, both follower frames 23, 33 are returned to the original positions with respect to the vertical direction and the width direction of the automobile body (B). As both follower frames 23, 33 are returned to the original positions, the slide cylinder 11 is activated toward the front side and the sealant coating device 1 is returned to the original position in the front side.

The representative sealant coating device 1 includes the nozzles 24c, 34c for coating the sealant that are moved in the width direction and vertical direction of the automobile body in order to follow the panel joints (J). As a result, the representative sealant coating device 1 does not require a workpiece (automobile body) that is supported in a floating condition, such as known devices. Consequently, the supporting structure for the workpiece (automobile body) can have a relatively small and simple structure. In addition, the nozzles 24c, 34c can be made to accurately follow the panel joints (J), (J), thereby enabling a high-quality sealant coating process.

The present teachings are not limited to the representative examples and embodiments described above. Various modifications, additions, and deletions are possible without departing from the spirit of the present teachings. For example, although a sealant (C) was coated onto the joints of a roof panel (R) and roof side panel (S) in the representative embodiment, the present teachings naturally also can be utilized to coat sealant (C) onto other panel joints, such as floor panels.

Further, the present teachings can be utilized to perform other processing on a workpiece. For example, air guns could be mounted in place of the coating heads 24, 34 and the automobile body (B) can be cleaned by forcing the air guns follow the automobile body (B).

Although both the workpiece (automobile body) and the processing head (coating head) were capable of movement in the representative embodiment, one of the workpiece or the processing head could be fixed in a stationary position and the other of the workpiece and the processing head can move. In addition, both the processing head and the workpiece can move in the same direction. Furthermore, although the processing head was described as moving from the front side toward the backside of the workpiece, the processing head naturally could move from the back toward the front. If the workpiece (e.g. automobile body) is capable of movement relative to the processing head (e.g. coating head), the present teachings can be utilized with advantageous effects.

In the representative embodiment, the processing head (e.g. coating head) was supported to freely move in the left or right directions (e.g. the width direction of the automobile body) and the vertical direction (e.g. up and down directions) with respect to the supporting structure. However, the processing head could be supported to freely move in only one direction, i.e., either in left or right direction or in vertical direction relative to the supporting structure. In addition, the direction of movement can be suitably selected depending upon the shape and other features of the workpiece. It is only necessary that a processing head is supported by a supporting structure, which is free to move in such a manner that the processing head will follow the workpiece when the supporting structure is moved along the workpiece.

In another modification, various driving devices may be utilized instead of the driving cylinders 25, 27, 35, 37 described in the representative embodiment. Further, although a nozzle tip was designed to slip or drop into a concave shaped panel joint, the shape of the workpiece or the processing head can be changed as desired. In addition, the processing head is not required to be attached to the frame that was supported by the supporting structure, which is free to slide and free to rotate. Instead, various supporting mechanisms can be utilized as the supporting mechanism in order to support the processing head with respect to a supporting structure.

Naturally, the present teachings are not limited to processing automobile bodies and instead various workpieces can be processed according to the present teachings. In each case, an appropriate arrangement between the processing head and the workpiece can be selected according to techniques known in the art in view of the shape of the workpieces and the nature of the processing.

1. An apparatus for processing a portion of an automobile body comprising:
a processing device and
a supporting device movably supporting the processing device, wherein the supporting device is movable relative to the portion of the automobile body being processed.

2. An apparatus according to claim 1, wherein the processing device comprises a processing head.

3. An apparatus according to claim 1, wherein the apparatus is arranged and constructed such that movement of the automobile body causes the supporting device to move relative to the portion of the automobile body being processed.

4. An apparatus according to claim 1, wherein the apparatus is arranged and constructed such that the supporting device is movable relative to the portion of the automobile body being processed by moving both the automobile body and the supporting device.

5. An apparatus according to claim 1, wherein the processing device is movably supported on the supporting device in a width direction of the automobile body.

6. An apparatus according to claim 5, further comprising a transverse direction driving device for moving the processing device in a width direction of the automobile body.

7. An apparatus according to claim 6, further comprising a position detector for detecting the relative positions of the supporting device and the portion of the automobile body being processed, wherein a transverse direction driving device drives the supporting device based on detection signals generated by the position detector.

8. An apparatus according to claim 1, wherein the processing device is movably supported on the supporting device in a vertical direction of the automobile body.

9. An apparatus according to claim 8, further comprising a vertical direction driving device for moving the processing device in a vertical direction with respect to the automobile body.

10. An apparatus according to claim 9, further comprising a position detector for detecting the relative positions of the workpiece and the supporting device, wherein the vertical direction driving device drives the processing device based on detection signals generated by the position detector.

11. An apparatus according to claim 1, wherein the processing device is movably supported on the supporting device in a width direction and in a vertical direction of the automobile body.

12. An apparatus according to claim 11, further comprising a transverse direction driving device for moving the processing device in a width direction of the automobile body and a vertical direction device for moving the processing device in a vertical direction of the automobile body.

13. An apparatus according to claim 12, further comprising a position detector for detecting the relative positions of the workpiece and the supporting device, wherein the transverse direction driving device and the vertical direction driving device drive the processing device based on detection signals generated by the position detector.

14. An apparatus according to claim 1, further comprising a support mechanism movably supporting the processing device on the supporting device.

15. An apparatus according to claim 14, wherein the support mechanism movably supports the processing device in a width direction with respect to the automobile body.

16. An apparatus according to claim 14, wherein the support mechanism movably supports the processing device in a vertical direction with respect to the automobile body.

17. An apparatus according to claim 14, wherein the support mechanism movably supports the processing device in a width direction and in a vertical direction with respect to the automobile body.

18. An apparatus according to claim 17, wherein the support mechanism includes a atructure that is rotatably and slidably supported on the supporting structure.

19. A method for processing a portion of an automobile body using a processing device comprising:
moving a supporting device relative to the portion of the automobile body being processed while movably supporting the processing device on the supporting device.

20. A method according to claim 19, further comprising moving the supporting device relative to the portion of the automobile body being processed by moving the automobile body.

21. A method according to claim 19, further comprising moving the supporting device relative to the portion of the automobile body being processed by moving both the automobile body and the supporting structure.

22. A method according to claim 19, further comprising moving the supporting device relative to the portion of the automobile body being processed while movably supporting the processing device in a vertical direction with respect to the automobile body.

23. A method according to claim 19, further comprising moving the supporting device relative to the portion of the automobile body being processed while movably supporting the processing device in a width direction with respect to the automobile body.

24. A method according to claim 19, further comprising moving the supporting device relative to the portion of the automobile body being processed while movably supporting the processing device in a vertical direction and in a width direction eith respect to the automobile body.

25. An apparatus for processing a workpiece comprising:
a processing device and
a supporting device movably supporting the processing device, wherein the supporting device is movable relative to the portion of the workpiece being processed.

26. An apparatus according to claim 25, wherein the processing device comprises a processing head.

27. An apparatus according to claim 25, wherein the processing device is movably supported on the supporting device in a direction that is substantially parallel to a line connecting the supporting device and the portion of the workpiece being processed.

28. An apparatus according to claim 27, further comprising a first driving device for moving the processing device in a direction that is substantially parallel to the line connecting the supporting device and the portion of the workpiece being processed.

29. An apparatus according to claim 25, wherein the processing device is movably supported in a direction that is substantially parallel to a line that is orthogonal to a line connecting the supporting device and the portion of the workpiece being processed.

30. An apparatus according to 29, further comprising a second driving device for moving the processing device in a direction that is substantially parallel to a line that is orthogonal to the line connecting the supporting device and the portion of the workpiece being processed.

31. An apparatus according to claim 25, wherein the processing device is movably supported in a direction that is substantially parallel to a line connecting the supporting device and the portion of the workpiece being processed and in a direction that is substantially parallel to a line orthogonal to the line connecting the supporting device and the portion of the workpiece being processed.

32. An apparatus according to claim 31, further comprising a first driving device for moving the processing device in the direction that is substantially parallel to the line connecting the supporting device and the portion of the workpiece being processed, and a second driving device for moving the processing device in the direction that is substantially parallel to the line orthogonal to the line connecting the supporting device and the portion of the workpiece being processed.

33. An apparatus according to claim 25, wherein the processing device is movably supported on the supporting device in a direction opposite to a surface of the portion being processed.

34. An apparatus according to claim 25, wherein the processing device is movably supported on the supporting device in a direction that is substantially orthogonal to a surface of the portion being processed.

35. A method for processing a workpiece using a processing device comprising:
moving a supporting device relative to the portion of the workpiece being processed while the processing device is movably supported on the supporting device.

36. A method according to claim 35, further comprising moving the supporting device relative to the portion of the workpiece being processed while movably supporting the processing device in a direction that is substantially parallel to a line connecting the supporting device and the portion of the workpiece being processed.

37. A method according to claim 35, further comprising moving the supporting device relative to the portion of the workpiece being processed while movably supporting the processing device in a direction that is substantially parallel to a line orthogonal to a line connecting the supporting device and the portion of the workpiece being processed.

38. A method according to claim 35, further comprising moving the supporting device relative to the portion of the workpiece being processed while movably supporting the processing device in a direction that is opposite to a surface of the portion being processed.

39. A method according to claim 35, further comprising moving the supporting device relative to the portion of the workpiece being processed while movably supporting the processing device in a direction that is substantially orthogonal to a surface of the portion being processed.

40. A method according to claim 35, further comprising moving the supporting device relative to the portion of the workpiece being processed while movably supporting the processing device in a direction that is substantially parallel to a line connecting the supporting device and the portion of the workpiece being processed and in a direction that is substantially parallel to a line orthogonal to the line connecting the supporting device and the portion of the workpiece being processed.

41. An apparatus for processing an automobile body comprising:
a supporting structure comprising a first arm and a second arm,
a first follower frame,
a second follower frame coupled to an end portion of the second arm, the first and second follower frames respectively comprising first, second and third transversely disposed frames, wherein the second transversely disposed frame of the first follower frame is coupled to an end portion of the first arm and the second transversely disposed frame of the second follower frame is coupled to an end portion of the second arm,
a first transverse driving cylinder coupled and transversely disposed with respect to the first arm, the first transverse driving cylinder comprising a rod actuatable to move between an extended position and a retracted position, wherein when the rod is extended in the extended position, the first follower frame is locked in the transverse direction, and when the rod is withdrawn to the retracted position, the first follower frame can freely move in the transverse direction,
a second transverse driving cylinder coupled and transversely disposed with respect to the second arm, the second transverse driving cylinder comprising a rod actuatable to move between an extended position and a retracted position, wherein when the rod is extended in the extended position, the second follower frame is locked in the transverse direction, and when the rod is withdrawn to the retracted position, the second follower frame can freely move in the transverse direction,
a first vertical driving cylinder coupled and vertically disposed with respect to the first arm, the first vertical driving cylinder comprising a rod actuatable to move between an extended position and a retracted position, wherein when the rod is extended in the extended position, the first follower frame is locked in the vertical direction, and when the rod is withdrawn to the retracted position, the first follower frame can freely move or pivot in the vertical direction,
a second vertical driving cylinder coupled and vertically disposed with respect to the second arm, the second vertical driving cylinder comprising a rod actuatable to move between an extended position and a retracted position, wherein when the rod is extended in the extended position, the second follower frame is locked in the transverse direction, and when the rod is withdrawn to the retracted position, the second follower frame can freely move or pivot in the vertical direction,
a first processing device coupled to the first follower frame and
a second processing device coupled to the second follower frame, the first and second processing devices being selected from the group consisting of a spray nozzle and an air gun.
